(19) United States
(12) Patent Application Publication
(10) Pub. No.: US 2026/0072917 A1
(43) Pub. Date: Mar. 12, 2026

(54) SYSTEM AND METHOD FOR PROCESSING CONTINUOUS QUERIES RESPONSIVE TO THE ABSENCE OF CHANGE

(71) Applicant: Microsoft Technology Licensing, LLC, Redmond, WA (US)

(72) Inventor: Daniel Donald Gerlag, Chilliwack (CA)

(21) Appl. No.: 18/828,691

(22) Filed: Sep. 9, 2024

(51) Int. Cl. G06F 16/2455

(52) U.S. Cl. CPC G06F 16/24568

(57) ABSTRACT

A method, computer program product, and computing system for processing a continuous query with a future condition on a source element from database of elements to generate an initial result and determining that the future condition is unmet. The future condition is enqueued in a re-evaluation queue. The future condition from the re-evaluation queue is reprocessed on the database of elements based upon, at least in part, the initial result, the future condition, and a current time.

### BACKGROUND

When processing a query on data elements within a database or other data structure, the query may include a continuous or ongoing condition to be assessed in response to a change in the underlying data elements. However, conventional query management for continuous queries executed on a database are unable to process situations where no change occurs in the underlying data elements.

### BRIEF DESCRIPTION OF THE DRAWINGS

FIG. 1 is a flow chart of one implementation of a continuous query management process;

FIGS. 2-3 are diagrammatic views of the continuous query management process; and

FIG. 4 is a diagrammatic view of computer system and a continuous query management process coupled to a distributed computing network.

Like reference symbols in the various drawings indicate like elements.

### DETAILED DESCRIPTION

Implementations of the present disclosure provide the ability for a continuous query to schedule a future time at which the solution currently being processed will be re-evaluated against the continuous query. Typically, query management approaches require an incoming change from source data that causes a continuous query result to change in order to trigger a reaction. This approach works well for many continuous queries, but there is a category of use cases that require a reaction to fire in the absence of a change in the source data. The challenge with applying this to a continuous query is that a condition may not be satisfied when a change to the source data occurs, but with the passage of time, where the condition eventually becomes satisfied. However, because conventional query management approaches do not receive change events for the source data, the source data is not re-evaluated for potential inclusion in the continuous query result. Accordingly, the continuous query management process allows for the re-evaluation of the condition at some time in the future (i.e., a future condition) in the absence of an incoming change event from the source data.

Accordingly, implementations of the present disclosure process a continuous query with a future condition on a source element from database of elements to generate an initial result. The continuous query is evaluated to determine whether the future condition is satisfied. When the future condition is determined to be unmet, the future condition is enqueued in a re-evaluation queue (i.e., a queue for holding continuous queries that are accessed and re-processed when a future condition is met).

The future condition from the re-evaluation queue is reprocessed on the database of elements based upon, at least in part, the initial result, the future condition, and a current time. For example, in response to determining that the timing for the future condition has been met, the continuous query management process the latest version of the source element from the database of elements and reprocesses the continuous query. In one example, the continuous query concerns a condition to evaluate at a future time (i.e., whether the condition is met later at the future time). In another example, the continuous query concerns a condition to evaluate for a future period of time (i.e., whether the condition is met for a period of time in the future). In another example, the continuous query concerns a condition to evaluate until a future time (i.e., whether the condition is met until a future time).

Accordingly, the continuous query management process addresses the problem of changing the output of a continuous query even when no event is received by providing extension functions to a query language that allows the user to express a condition that must be true at some time in the future, or hold true for a specified period. When these functions are initially triggered by incoming events, they enqueue future conditions on a re-evaluation queue that is ordered by the future time that the query should be reevaluated. The continuous query management process employs a background process the monitors the head item in the re-evaluation queue, and processes it if the target time becomes the current time.

The details of one or more implementations are set forth in the accompanying drawings and the description below. Other features and advantages will become apparent from the description, the drawings, and the claims.

### The Continuous Query Management Process

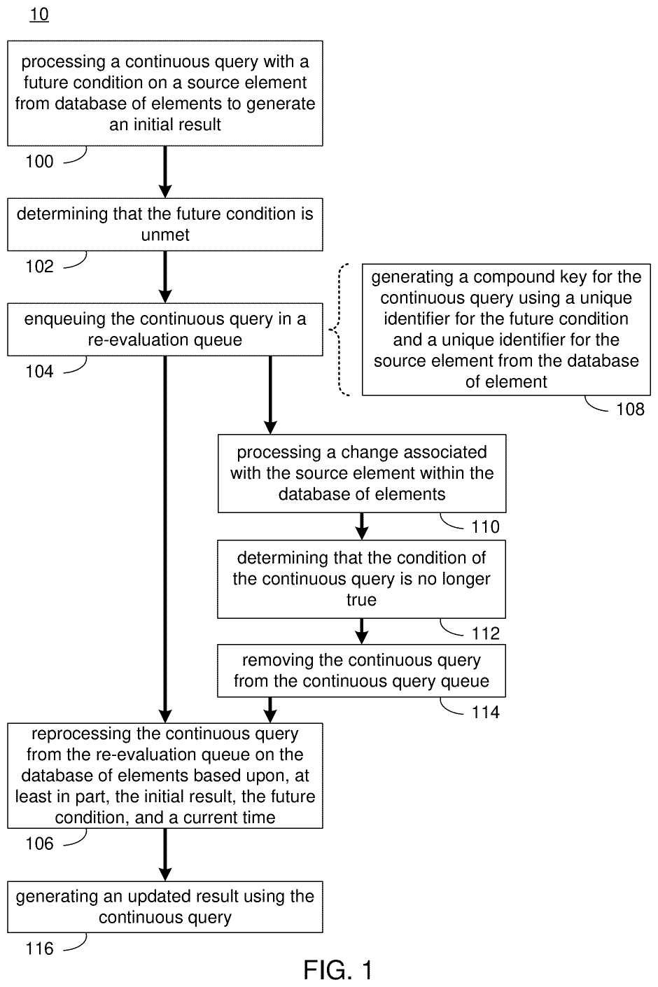

Referring to FIGS. 1-3, continuous query management process 10 processes 100 a continuous query with a future condition on a source element from database of elements to generate an initial result and determines 102 that the future condition is unmet. The future condition is enqueued 104 in a re-evaluation queue. The continuous query from the re-evaluation queue is reprocessed 106 on the database of elements based upon, at least in part, the initial result, the future condition, and a current time.

In some implementations, continuous query management process 10 processes 100 a continuous query with a future condition on a source element from database of elements to generate an initial result. A continuous query is a query (i.e., a request for information concerning a source element with conditional logic for evaluating various elements within the database of elements) that is issued once over a database of elements, and then logically runs continuously over the source element (i.e., target data of the continuous query) until the continuous query is terminated. In this manner, a continuous query allows a querying entity (i.e., a user) to obtain new or updated results concerning the source element without having to issue the same query repeatedly. In some implementations, a continuous query is generated by a computing device (e.g., in response to a user providing a text-based query with conditional logic to the computing device) and executed on the database of elements.

Typical continuous queries include logic that is responsive to a change in the source element. However, conventional approaches are unable to account for the absence of a change in the source element. For example, suppose a database included source elements concerning invoices. In this example, suppose a user desires to identify overdue invoices such that a collections workflow is initiated when an invoice remains unpaid for more than three days. A regular, non-continuous query may compare identify invoices with a date that is three days in the past and is currently unpaid. The challenge with applying this to a continuous query is that the condition concerning an unpaid invoice may not be “true” when a change to the invoice occurs, but with the passage of time, the condition will eventually become “true”. In this example, because conventional query management systems would not receive any change events for the invoice, the invoice will not be re-evaluated for potential inclusion in the continuous query result. In this case, the invoice would need to be re-evaluated at some time in the future in the absence of an incoming change event from the database.

Accordingly, continuous query management process 10 processes 100 a continuous query with a future condition. A future condition is condition that defines a future point in time, or range of future time for evaluation. In one example, the future condition defines a condition to evaluate at a future time. For instance, the continuous query includes two arguments: a condition expression and a timestamp. As will be discussed in greater detail below, continuous query management process 10 ensures that the condition expression is evaluated at the time specified by the timestamp. In this manner, the future condition determines whether a condition is true (or false) at some later point in the future.

In another example, the future condition defines a condition to evaluate for a future period of time. For instance, suppose a query concerns a current temperature of a freezer determined by a sensor or sensors communicatively coupled to a database of elements such that the current temperature is periodically recorded in the database of elements. In this example, suppose a user desires to receive an alert when a freezer remains above a threshold temperature (e.g., 32 degrees Fahrenheit) continuously for more than a threshold amount of time (e.g., fifteen minutes). The continuous query includes two arguments for the future condition: a condition and a duration of how long the condition needs to be true. The continuous query would be returned as true by continuous query management process 10 only when the condition has been held for the specified duration. In another example, the future condition defines a condition to evaluate until a future time. For instance, the continuous query includes two arguments: a condition expression and a timestamp. The continuous query would be returned as true by continuous query management process 10 only when the condition has been held until the timestamp defined within the future condition. In some implementations, continuous query management process 10 processes 100 the continuous query to generate an initial result. The initial result is an initial evaluation of the continuous query based on the source element at the time of the continuous query is processed. As will be discussed in greater detail below, the initial result may be referenced by the continuous query in during reprocessing.

In some implementations, continuous query management process 10 determines 102 that the future condition is unmet. For example, upon processing 100 the continuous query, continuous query management process 10 evaluates the future condition. For example, when a query engine of continuous query management process 10 evaluates the continuous query concerning the unpaid invoice(s) after three days, continuous query management process 10 first checks if the timestamp within the continuous query has elapsed by comparing it to the timestamp of an incoming source element change. In this example, when the timestamp within the continuous query is unmet, continuous query management process 10 determines 102 that the future condition is unmet.

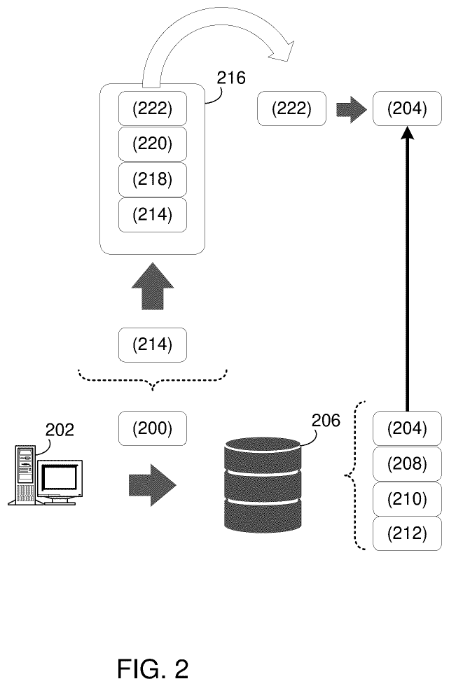

In some implementations, continuous query management process 10 enqueues 104 the future condition in a re-evaluation queue. For example and referring also to FIG. 2, suppose a continuous query (e.g., continuous query 200) is processed 100 (after receiving continuous query 200 from computing device 202) for a source element (e.g., source element 204) from a database of elements (e.g., database 206 of elements 204, 208, 210, 212) and continuous query management process 10 determines 102 that the future condition (e.g., future condition 214) is unmet (i.e., the future time has not elapsed). In this example, continuous query management process 10 enqueues 104 future condition 214 in a re-evaluation queue (e.g., re-evaluation queue 216 with future conditions 218, 220, 222). Re-evaluation queue 216 is a data structure that holds a predefined number of future conditions for subsequent reprocessing. For example, re-evaluation queue 216 is a priority queue that can be persisted to a storage device and can store any number of future conditions (i.e., zero or more future conditions). In some implementations, continuous query management process 10 generates and manages a separate re-evaluation queue for each continuous query/type of continuous query. In one example, the re-evaluation queue (e.g., re-evaluation queue 216) is a priority queue ordered by the occurrence of the future condition. For example, the future condition that occurs next is at the head of re-evaluation queue 216 and the future condition that occurs the furthest in the future is at the tail of re-evaluation queue 216.

In some implementations, enqueuing 104 the future condition in the re-evaluation queue includes generating 108 a compound key for the continuous query using a unique identifier for the future condition and a unique identifier for the source element from the database of element. For example, continuous query management process 10 generates 108 a compound key using a unique identifier for the future condition (i.e., a symbol or combination of symbols indicative of a position of the future condition within continuous query 200) and a unique identifier for the source element (i.e., a symbol or combination of symbols generated to represent the source element). For example, using the unique identifier for the future condition, continuous query management process 10 is able to enqueue multiple future conditions of a continuous query for individual reprocessing. In some implementations, continuous query management process 10 enqueues 104 the future condition in re-evaluation queue 216 by pushing a compound key for the continuous query in re-evaluation queue with other potential query solutions that need to be reprocessed at some time in the future. In some implementations, continuous query management process 10 returns a “null” result. If this causes an entire future condition to evaluate to “null”, which may be desirable in continuous queries, the query solution being evaluated is not part of the query result.

In some implementations, continuous query management process 10 processes 110 a change associated with the source element within the database of elements. For example, continuous query management process 10 processes 110 notifications of changes or updates to individual source elements within the database of elements. As discussed above, a continuous query is processed with a future condition that is response to changes in a source element. In some implementations, processing 110 the change associated with the source element includes determining 112 that the condition of the continuous query is no longer true; and removing 114 the future condition from the re-evaluation queue. For example, suppose future condition 214 concerns whether a freezer remains above a threshold temperature (e.g., 32 degrees Fahrenheit) continuously for more than a threshold amount of time (e.g., fifteen minutes). In this example, if the future condition resolves true (i.e., the freezer temperature is above 32 degrees), then the compound key is added to re-evaluation queue 216 only if it is not already in re-evaluation queue 216. If the condition resolves false, then if that compound key is already in re-evaluation queue 216, continuous query management process 10 removes 114 future condition 218 (i.e., the compound key for a continuous query with future condition 218) from re-evaluation queue 216. In this example, continuous query management process 10 processes changes and removes the future condition as follows:
12:00->The freezer temperature is 35 degrees->[future condition 218; 12:15].
12:01->The freezer temperature is 36 degrees->[future condition 218; 12:15].
12:02->The freezer temperature is 30 degrees->[].
12:14->The freezer temperature is 34 degrees->[new future condition; 12:29].

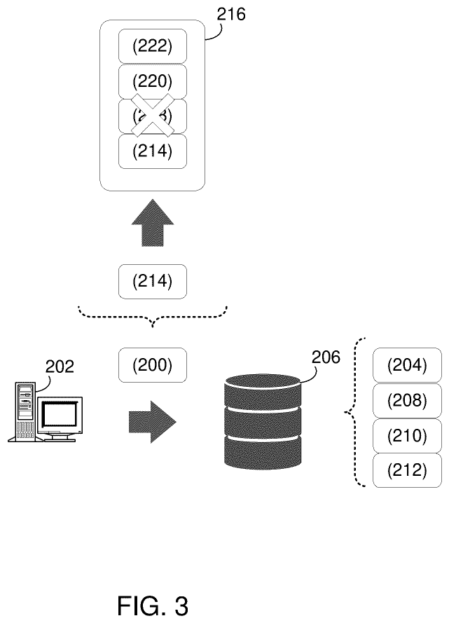

As shown above and in FIG. 3, because the temperature of the freezer changes at 12:02 and is determined to no longer satisfy the future condition, continuous query management process 10 removes future condition 218 and when continuous query management process 10 determines that the temperature of the freezer changes at 12:14 to 34 degrees and is determined to satisfy the future condition, continuous query management process 10 adds a new future condition to re-evaluation queue 216.

In some implementations, continuous query management process 10 reprocesses 106 the continuous query from the re-evaluation queue on the database of elements based upon, at least in part, the initial result, the future condition, and a current time. For example, continuous query management process 10 executes a background process that monitors the head item in re-evaluation queue 216. When the timestamp of the head item is less than the current time, the respective future condition is dequeued and continuous query management process 10 reprocesses 106 the latest version of the source element through the continuous query. In some implementations, because of the logic used by the future condition, the future condition timestamp is guaranteed to be greater than the current time. If the future condition (e.g., the compound key of the future condition) reaches the head of re-evaluation queue 216 and it's time expires, the source element is reprocessed through the query and the future condition returns a “true” result which triggers a reaction (as defined by continuous query or a dependent process/application).

In some implementations, continuous query management process 10 generates 116 an updated result using the continuous query. For example and referring again to FIG. 2, continuous query management process 10 determines that the temporal condition of the future condition is met and “pops” future condition 222 from re-evaluation queue 216 and continuous query management process 10 reprocesses 106 the continuous query including future condition 222 using an up-to-date version of the source element (e.g., source element 204). As the future condition is met, continuous query management process 10 returns the result of the continuous query (i.e., a Boolean value, a reference to a source element, metadata concerning the source element(s), etc.). In some implementations, continuous query management process 10 provides the updated result to the querying device (e.g., computing device 202). In one example, providing the updated result includes generating an alert or notification concerning the continuous query. In another example, providing the updated result includes performing an automated action defined by the continuous query and/or the querying computing device (e.g., computing device 202). Accordingly, continuous query management process 10 processes continuous queries based on an absence in change by managing a re-evaluation queue defined with future conditions. In this manner, continuous queries are resolved over time without requiring a notification of a change in the source element.

### System Overview

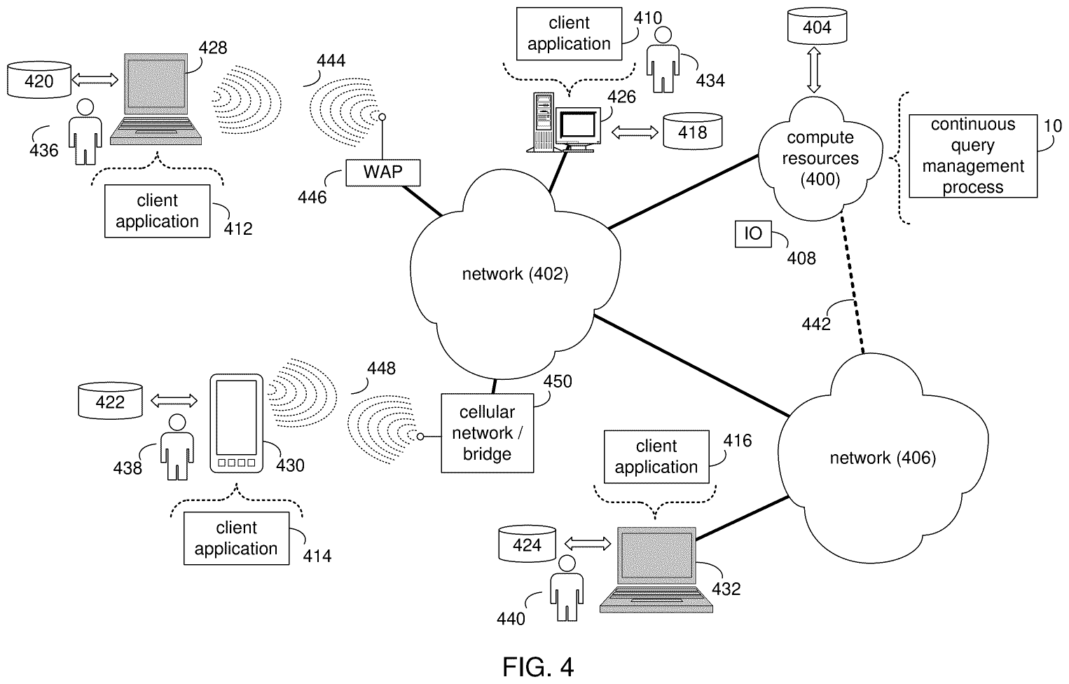

Referring to FIG. 4, a continuous query management process 10 is shown to reside on and is executed by compute resources 400, which is connected to network 402 (e.g., the Internet or a local area network). Examples of compute resources 400 include: a Network Attached Storage (NAS) system, a Storage Area Network (SAN), a personal computer with a memory system, a server computer with a memory system, and a cloud-based device with a memory system. A SAN includes one or more of a personal computer, a server computer, a series of server computers, a minicomputer, a mainframe computer, a RAID device, and a NAS system.

The various components of compute resources 400 execute one or more operating systems, examples of which include: Microsoft® Windows®; Mac® OS X®; Red Hat® Linux®, Windows® Mobile, Chrome OS, Blackberry OS, Fire OS, or a custom operating system (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of continuous query management process 10, which are stored on storage device 404 included within compute resources 400, are executed by one or more processors (not shown) and one or more memory architectures (not shown) included within compute resources 400. Storage device 404 may include: a hard disk drive; an optical drive; a RAID device; a random-access memory (RAM); a read-only memory (ROM); and all forms of flash memory storage devices. Additionally or alternatively, some portions of the instruction sets and subroutines of continuous query management process 10 are stored on storage devices (and/or executed by processors and memory architectures) that are external to compute resources 400.

In some implementations, network 402 is connected to one or more secondary networks (e.g., network 406), examples of which include: a local area network; a wide area network; or an intranet.

Various input/output (IO) requests (e.g., IO request 408) are sent from client applications 410, 412, 414, 416 to compute resources 400. Examples of IO request 408 include data write requests (e.g., a request that content be written to compute resources 400) and data read requests (e.g., a request that content be read from compute resources 400).

The instruction sets and subroutines of client applications 410, 412, 414, 416, which may be stored on storage devices 418, 420, 422, 424 (respectively) coupled to client electronic devices 426, 428, 430, 432 (respectively), may be executed by one or more processors (not shown) and one or more memory architectures (not shown) incorporated into client electronic devices 426, 428, 430, 432 (respectively). Storage devices 418, 420, 422, 424 may include: hard disk drives; tape drives; optical drives; RAID devices; random access memories (RAM); read-only memories (ROM), and all forms of flash memory storage devices. Examples of client electronic devices 426, 428, 430, 432 include personal computer 426, laptop computer 428, smartphone 430, laptop computer 432, a server (not shown), a data-enabled, and a dedicated network device (not shown). Client electronic devices 426, 428, 430, 432 each execute an operating system.

Users 434, 436, 438, 440 may access compute resources 400 directly through network 402 or through secondary network 406. Further, compute resources 400 may be connected to network 402 through secondary network 406, as illustrated with link line 442.

The various client electronic devices may be directly or indirectly coupled to network 402 (or network 406). For example, personal computer 426 is shown directly coupled to network 402 via a hardwired network connection. Further, laptop computer 432 is shown directly coupled to network 406 via a hardwired network connection. Laptop computer 428 is shown wirelessly coupled to network 402 via wireless communication channel 444 established between laptop computer 428 and wireless access point (e.g., WAP) 446, which is shown directly coupled to network 402. WAP 446 may be, for example, an IEEE 802.11a, 802.11b, 802.11g, 802.11n, Wi-Fi®, and/or Bluetooth® device that is capable of establishing a wireless communication channel 444 between laptop computer 428 and WAP 446. Smartphone 430 is shown wirelessly coupled to network 402 via wireless communication channel 448 established between smartphone 430 and cellular network/bridge 450, which is shown directly coupled to network 402.

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be used. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet.

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, not at all, or in any combination with any other flowcharts depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

1. A computer-implemented method, executed on a computing device, comprising:
receiving a continuous query comprising a future condition to be applied to elements of a database;
generating, at an initial time, an initial result for the continuous query based on the future condition being applied to a source element of the database;
determining that the future condition is initially unmet based on the initial result;
enqueuing the future condition in a re-evaluation queue, the re-evaluation queue comprising one or more future conditions to be evaluated at future times; and
evaluating the future condition of the continuous query from the re-evaluation queue against the database of elements based upon, at least in part, the initial result, the future condition, and a current time, wherein the current time is later that the initial time.

2. The computer-implemented method of claim 1, further comprising:
generating an updated result using the continuous query.

3. The computer-implemented method of claim 1, wherein the future condition defines a condition to evaluate at a future time.

4. The computer-implemented method of claim 1, wherein the future condition defines a condition to evaluate for a future period of time.

5. The computer-implemented method of claim 1, wherein the future condition defines a condition to evaluate until a future time.

6. The computer-implemented method of claim 1, wherein enqueuing the future condition in the re-evaluation queue comprises:
generating a compound key for the continuous query using a unique identifier for the future condition and a unique identifier for the source element from the database of element.

7. The computer-implemented method of claim 1, further comprising:
processing a change associated with the source element within the database of elements.

8. A computing system comprising:
a memory; and
a processor, operatively coupled to the memory, configured to;
receive a continuous query comprising a future condition to be applied to elements of a database;
generate, at an initial time, an initial result for the continuous query based on the future condition being applied to a source element of the database;
process a continuous query with a future condition on a source element from database of elements to generate an initial result,
determine that the future condition is initially unmet based on the initial result,
enqueue the future condition in a re-evaluation queue, the re-evaluation queue comprising one or more future conditions to be evaluated at future times,
evaluating the future condition of the continuous query from the re-evaluation queue against the database of elements based upon, at least in part, the initial result, the future condition, and a current time, wherein the current time is later than the initial time, and
generate an updated result using the continuous query.

9. The computing system of claim 8, wherein the future condition defines a condition to evaluate at a future time.

10. The computing system of claim 8, wherein the future condition defines a condition to evaluate for a future period of time.

11. The computing system of claim 10, wherein the processor is further configured to:
determine that the condition of the continuous query is no longer true; and
remove the future condition from the re-evaluation queue.

12. The computing system of claim 8, wherein the future condition defines a condition to evaluate until a future time.

13. The computing system of claim 8, wherein to enqueue the future condition in the re-evaluation queue the processor is configured to:
generate a compound key for the continuous query using a unique identifier for the future condition and a unique identifier for the source element from the database of element.

14. The computing system of claim 8, wherein the processor is further configured to process a change associated with the source element within the database of elements.

15. A non-transitory computer readable medium having instructions stored thereon which, when executed by a processor, cause the processor to:
receive a continuous query comprising a future condition to be applied to elements of a database;
generate, at an initial time, an initial result for the continuous query based on the future condition being applied to a source element of the database;
process a continuous query with a future condition on a source element from database of elements to generate an initial result;
determine that the future condition is initially unmet based on the initial result;
enqueue the future condition in a re-evaluation queue, the re-evaluation queue comprising one or more future conditions to be evaluated at future times;
process a change associated with the source element within the database of elements;
evaluating the future condition of the continuous query from the re-evaluation queue against the database of elements based upon, at least in part, the initial result, the future condition, the change associated with the source element, and a current time, wherein the current time is later than the initial time; and
generating an updated result using the continuous query.

16. The non-transitory computer readable medium of claim 15, wherein the future condition defines a condition to evaluate at a future time.

17. The non-transitory computer readable medium of claim 15, wherein the future condition defines a condition to evaluate for a future period of time.

18. The non-transitory computer readable medium of claim 17, wherein to process the change associated with the source element the processor is further to:
determine that the condition of the continuous query is no longer true; and
remove the future condition from the re-evaluation queue.

19. The non-transitory computer readable medium of claim 15, wherein the future condition defines a condition to evaluate until a future time.

20. The non-transitory computer readable medium of claim 15, wherein to enqueue the future condition in the re-evaluation queue the processor is to:
generate a compound key for the continuous query using a unique identifier for the future condition and a unique identifier for the source element from the database of element.
